(19) United States
(12) Patent Application Publication
(10) Pub. No.: US 2020/0291732 A1
(43) Pub. Date: Sep. 17, 2020

(54) Filtration System for Use in a Shale Shaker

(71) Applicant: Richard Ooi, Butterworth (MY)

(72) Inventor: Richard Ooi, Butterworth (MY)

(21) Appl. No.: 16/352,133

(22) Filed: Mar. 13, 2019

(51) Int. Cl. E21B 21/06; B01D 33/03; B01D 33/41; B01D 39/10

(52) U.S. Cl. CPC E21B 21/065; B01D 33/0376; B01D 2201/188; B01D 39/10; B01D 2201/34; B01D 33/41

(57) ABSTRACT

Embodiments of a shale shaker filtration system of the present invention generally include a filtration component, a positioning component, and a frame, wherein the filtration component includes at least one screen having one or more layers of a sieving material, the positioning component includes one or more first connecting members and one or more second connecting members, and the frame is sub-divided into a plurality of units having openings; and wherein each positioning component is disposed at least partially within a frame unit opening and is reversibly engaged with the frame via the second connecting member(s), and each filtration component is disposed on top of a positioning component and is reversibly engaged therewith via the first connecting member(s). Embodiments of a method of filtering solid materials from a liquid utilizing embodiments of a shale shaker filtration system of the present invention are also provided.

### CROSS-REFERENCE TO RELATED APPLICATIONS

None

### STATEMENT REGARDING FEDERALLY SPONSORED RESEARCH OR DEVELOPMENT

None

### FIELD OF THE INVENTION

The invention generally relates to a system for use in a shale shaker, and more specifically the system is used for filtering solid matter from drilling fluids.

### BACKGROUND OF THE INVENTION

Drilling operations are common across the oil and gas, construction, and mining industries. For the oil and gas industry, whether onshore or offshore, drilling is considered one of the first steps in the process of extracting hydrocarbon-based resources. In the drilling process, a hole is bored in the earth with a drilling rig by rotating a drill bit attached to a drill string. Drilled rocks, sand, and metals etc., known generally as cuttings or solids, reduce drilling speed and increase drilling cost. Accordingly, drilling fluid(s), also known as “mud,” is circulated from the rig surface to the bottom of the wellbore (“hole”), proximate the drill bit, to remove the cuttings. Cuttings are transported from the bottom of the hole to the surface, where, typically, a series of devices known as shale shakers are used to filter the cuttings from the valuable drilling fluid. The filtered mud is collected and pumped downhole for reuse, forming a closed-loop drilling fluid system throughout the drilling process.

Generally, the screening devices are referred to as shale “shakers” because vibrational motion (i.e., “shaking”) of the apparatuses is utilized to assist in the filtration process. Shale shakers are very important in the drilling process because they are the first line of defense against solids contamination, as solids bypassing the shale shakers can cause significant operational costs. In addition to the cost of having to filter the same solids more than once, increased chemical consumption, fluid dilution, reduced drilling speed, and damaged equipment are additional effects of solids contamination in mud.

Generally, in a shale shaker a plurality of filter screen components are aligned adjacent to each other within a shaker bed to filter cuttings from the mud. The filter screen components are mainly the mesh and frame, whereby one or more mesh layers are employed to prevent solids above a certain diameter from passing through. This maximum particle size that a given shaker screen will allow to pass there through is known as the filtration “cut point.” The screen mesh layer(s) act as a sieving mechanism while the frame provides structural integrity to the mesh while it operates under vigorous vibration, temperature, and load.

Although shale shakers have long been used in drilling operations, it is difficult to replace the filter screens in the shale shakers, and life of the filter screens is short. The replacement of the filter screens in shale shakers normally requires delaying or even halting the drilling operations, where workers have to unlock the present filter screens and remove them from the shaker bed, insert new filter screens, and lock them in place before restarting the shale shakers to resume drilling operations. In some shaker models, filter screens are horizontally aligned next to each other. Accordingly, if the damaged filter screen that has to be removed and replaced is positioned on an inner part of the shale shaker, all of the other filter screens that are arranged in line outside it will have to be removed first in order to get to the damaged filter screen out. In addition, due to the weight and bulkiness of the screens, the replacement process is considered tedious and wastes valuable drilling time. Moreover, since vigorous vibration is applied to the screens during the filtration process, friction between cuttings and screens will eventually wear the mesh down, and abrasions, tears, and punctures of the screens are common.

Routine visual inspections are conducted to try to identify these defects. It is often difficult for workers to visually identify damaged filter screens since they are constantly covered by mud and cuttings while shakers are operating. Frequently, screen damage is only identified many hours or even days after defects arise, and high volumes of solids bigger than the cut point have passed through without being filtered. Since there is no preventive solution to solids bypass available today, screen replacement is necessarily conducted after the fact and the impact of solids contamination is absorbed each time a screen is damaged.

Once a damaged screen is identified and removed, it is common for workers to patch the hole(s) in order to continue using the filter screen longer. However, as the patch replaces an area of filtration with a non-sieve surface, every time a repair is conducted, the effective screen area is reduced along with its efficiency in processing mud. Accordingly, after several repairs, the entire filter screen is typically replaced with a brand new screen. The damaged screen will be discarded, even though a large fraction of the screen area is still in pristine condition. This approach is very wasteful.

Since oil rigs commonly operate in remote locations, logistics can pose a major challenge to operations. It is time consuming and costly to transport shaker screens to the drilling sites, especially to offshore facilities. In one aspect, filter screen manufacturers normally pack their screens in a box and transport them to the nearest supply warehouse, usually near a jetty, before shipping them out to the end users offshore. At the oil rigs, screens that were packed in boxes have to be hand-carried to the site location where the shale shakers are positioned. The transport process can involves many transfers using cranes and forklifts. Not only does this result in high logistics costs, it is also common for the filter screens to arrive having been damaged in transit.

With regard to the prior art in this field, disclosed in United Kingdom Patent No. GB 2245191 to Bailey et al. is a filter screen assembly having a plurality of modular screen units. With the use of the filter screen assembly described therein, only the damaged screen need be changed and replaced, instead of having to replace the entire filter screen. The patent further discloses that each modular screen unit has a snap engagement means allowing the screen unit to be fitted accordingly. While this patent teaches a simplified process for filter screen replacement, the invention does not provide for convenient removal the screen unit from the shale shaker. Instead, the invention requires that the user has to cut around the periphery of the screen unit before placing a new screen unit into the slot. As would be understood by one skilled in the art, considering the strength and precision required to cut a screen, it is believed that to employ the device of Bailey et al. the entire filter screen would have to be removed from the shaker bed prior to work. Furthermore, additional tools would have to be used to cut the screen unit away from the assembly, and it would be difficult to ensure that the damaged screen unit is cut correctly without damaging any of its neighboring units, not to mention the risk of injury in handling prickly steel mesh.

U.S. Pat. No. 9,180,493 to Dahl also discloses a shaker screen filter for a drilling fluid shaker. Similar to GB 224519, the Dahl patent similarly provides modular units of filter screens that can be replaced when screen damage occurs. Specifically, this patent discloses a filtration system that provides a plurality of cell plug filters, wherein each filter comprises an engagement mechanism arranged for locking the cell plug filters onto the main frame. Importantly, the patent application discloses the use of a screw mechanism to lock and release the filter from the main frame. It is believed that such replacement process would require a special tool to operate the screw mechanism. Further, the technology disclosed in the Dahl patent also is necessarily heavy and quite wasteful, because the entire screw mechanism has to be discarded along with the screen when damage occurs.

U.S. Pat. No. 9,744,564 to Cady discloses an apparatus relating to a vibratory separator screen utilizing a multiple screen design, where the apparatus comprises a plurality of modular inserts wherein mesh screen surfaces are stacked on a screen frame. While this patent provides modularity, it does not provide any greater level of convenience of screen replacement than Bailey et al. or Dahl above. As the invention is disclosed in Cady, the entire screen has to be removed from the shaker bed in order to remove the damaged insert, as they can only be slid out from the sides. Further, there is no disclosure of any element that prevent the bypass of solids through the connections between the screens.

Thus, despite the disclosure of modular filter screens in the prior art, no convenient and useful modular solution exists in the field, which why in the market currently the repair method of choice still requires blinding the damaged location, either with a snap-able plug or silicone putty. Both patching means reduce the screening surface and the filtration efficiency. After a few patching repairs, the entire screen must be replaced to maintain trade-off between screen life and filtration efficiency.

### BRIEF SUMMARY OF THE INVENTION

Embodiments of a filtration system for use in a shale shaker generally comprise a frame with a plurality of sub-divided openings, and a plurality of screen apparatuses, each comprising a filtration component reversibly coupled to a positioning component, wherein the screen apparatuses are adapted and configured for placement into the frame openings, wherein each filtration component comprises a screen which comprises a one or more mesh layers, and wherein a first connecting member reversibly secures the filtration component in position in relation to the positioning component, and a second connecting member reversibly secures the positioning component in the sub-divided frame opening. In one aspect, the invention provides an apparatus for use in a shale shaker and a filtration method that allows for the filtration component to be installed and removed in a simplified manner.

Embodiments of the invention also provide an apparatus for use in a shale shaker that is configurable to multiple cut points, and provides a preventive solution to solids bypass in the event of screen damage. Additionally, the invention allows workers to readily replace only damaged screens with new non-blanked screens, thereby all keeping in service all existing filter screens that are undamaged. Finally, the invention provides an apparatus for use in a shale shaker that is modular in size and light in weight, where the apparatus can be conveniently packed and shipped, thereby saving time, cost and labor.

### BRIEF DESCRIPTION OF DRAWINGS

The invention will now be described with reference to the drawings wherein:

FIG. 1 illustrates an exploded view of an embodiment of a screen apparatus of the present invention.

FIG. 2 illustrates an exploded view of an embodiment of a portion of a filtration system of the present invention.

FIG. 3a illustrates a perspective view of an embodiment of a positioning component of the present invention.

FIG. 3b illustrates a top view of the positioning component embodiment depicted in FIG. 3a.

FIG. 3c illustrates a bottom view of the positioning component embodiment depicted in FIG. 3a.

FIG. 3d illustrates a side view of an embodiment of a positioning component of the present invention.

FIG. 4a illustrates a perspective view of an embodiment of a filtration component of the present invention.

FIG. 4b illustrates a bottom view of the filtration component embodiment depicted in FIG. 4a.

FIG. 5a illustrates an embodiment of a filtration component of the present invention comprising one screen unit.

FIG. 5b illustrates an embodiment of a filtration component of the present invention comprising two screen units.

FIG. 5c illustrates an embodiment of a filtration component of the present invention comprising three screen units.

FIG. 6 illustrates an exploded view of an embodiment of a filtration component of the present invention comprising three screen units.

FIG. 7a illustrates a perspective, partial cross-sectional view of an embodiment of an installed screen apparatus of the present invention.

FIG. 7b illustrates a side, partial cross-sectional view of an embodiment of an installed screen apparatus of the present invention.

FIGS. 8a, 8b, and 8c illustrate a schematic representation of solids being filtered by embodiments of a filtration component of the present invention comprising one, two, and three mesh layers, respectively.

FIGS. 9a, 9b, 9c, 9d, and 9e illustrate embodiments of a filtration component of the present invention comprising various mesh to filtration component attachment configurations.

FIG. 10a illustrates an embodiment of a positioning component of the present invention engaged with an embodiment of a filtration component of the present invention.

FIG. 10b illustrates an embodiment of a positioning component of the present invention positioned within an embodiment of a frame opening of the present invention and engaged with an embodiment of a filtration component of the present invention.

### DETAILED DESCRIPTION OF EMBODIMENTS OF THE PRESENT INVENTION

The following description is presented to enable a person of ordinary skill in the art to make and use the various embodiments. Descriptions of specific devices, techniques, and applications are merely exemplary. Various modifications to the embodiments described herein will be readily apparent to those of ordinary skill in the art, and the general principals defined herein may be applied to other examples and applications without departing from the scope of the various embodiments. As used herein, directional indication terms such as, but not limited to, top, bottom, up, upward, upper, down, downward, lower, and like are for descriptive reference only as embodiments of components of the invention are configurable able in various orientations.

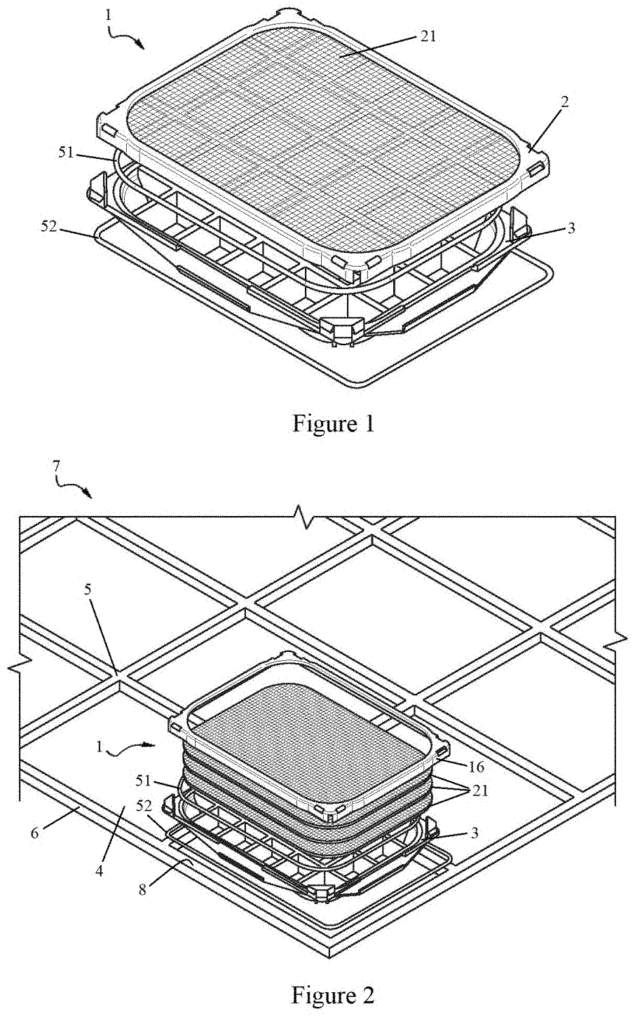

FIG. 1 illustrates an exploded view of an embodiment of a screen apparatus 1 of the present invention. In one embodiment, screen apparatus 1 comprises one or more filtration components 2 and a positioning component 3, and optionally, one or more first sealing devices 51 and/or second sealing devices 52. In one embodiment, a screen apparatus 1 is positionable within an opening 4 of a frame unit 6 of a frame 5, as depicted in FIG. 2.

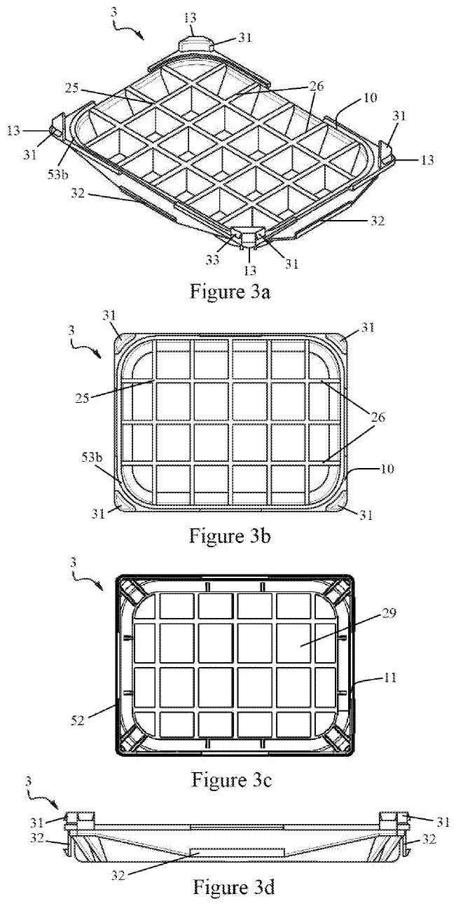

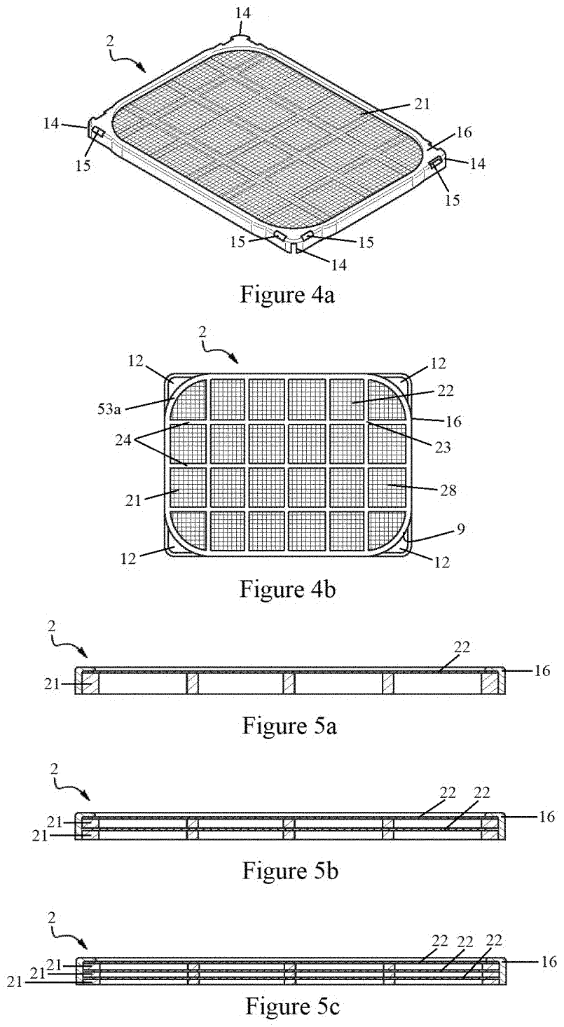

In one embodiment, a first sealing device 51 is positionable at least partially within an upper groove 53a of a bottom surface 9 of filtration component 2 (visible in FIG. 4b) and a lower groove 53b of a top surface 10 of positioning component 3 (shown in FIG. 3a) when filtration component 2 is engaged with positioning component 3, as visible in FIG. 7a. In other embodiments (not shown), a first sealing device 51 may be utilized in a screen apparatus 1 comprising only an upper groove 53a, only a lower groove 53b, or no groove. In one embodiment, a first sealing device 51 (and/or a second sealing device 52, discussed in detail below), may comprise an O-ring (also known as a toric joint), washer, or gasket, that may comprise an elastomeric (rubber) material, natural or synthetic. In one embodiment, a first sealing device 51 comprises nitrile rubber.

Referring again to FIG. 1, and also to FIG. 2, in one embodiment positioning component 3 is sized so that it may be snugly placed at least partially within an opening 4 of a frame unit 6, although the invention is not so limited and other configurations are contemplated. In one embodiment, filtration component 2 comprises width and length dimensions substantially similar to the width and length dimensions of positioning component 3; i.e., the two components are of substantially the same length and width. In other embodiments (not shown), a filtration component 2 may comprise width and/or length dimension less than that of the positioning component 3, such that a plurality of filtration components 2 may be positioned in cooperation with a positioning component 3. In one embodiment, filtration component 2 and positioning component 3 are adapted and configured to be cooperatively engaged with each other, as described below.

In one embodiment, a second sealing device 52 is positionable circumferentially about a bottom surface 11 of positioning component 3, as shown in FIG. 3c. In one embodiment (not shown), a bottom surface 11 of positioning component 3 comprises an upper groove (not shown) wherein a second sealing device 52 is positionable at least partially there within. In one embodiment, when positioning component 3 is engaged with frame 5 opening 4, second sealing device 52 is disposed between positioning component 3 and an upper surface 8 of frame 5, as shown in FIGS. 7a and 7b. In other embodiments (not shown) sealing device 52 may be disposed between positioning component 3 and another surface of frame 5. In other embodiments (not shown) a second sealing device 52 may be positioned elsewhere within a screen apparatus 1.

FIG. 2 depicts an embodiment of a modular filtration system 7 of the present invention, wherein only a single module (comprising a screen apparatus 1 in cooperation with a frame unit 6 opening 4) is shown. In one embodiment, frame 5 is subdivided into a plurality of units 6, each unit 6 comprising an opening 4 segregated from other openings 4 by portions of frame 5. In one embodiment, units 6 of a frame (and therefore, screen apparatuses 1) may be substantially rectangular in shape, as depicted FIG. 2, although the invention is not so limited and other shapes may be employed. In addition, units 6 of a frame 5 may all comprise the same shape or may be of different shapes. In one embodiment frame 5 comprises a metal material, such as, but not limited to, stainless steel, and/or a synthetic material, such as, but not limited to, plastic. In one embodiment (not shown), a filtration system 7 comprises a frame 5 having its plurality of frame units 6 equipped with such a module. As would be understood by one skilled in the art, a filtration system 7 may be employed in a standard shale shaker to filter drilling fluid solids.

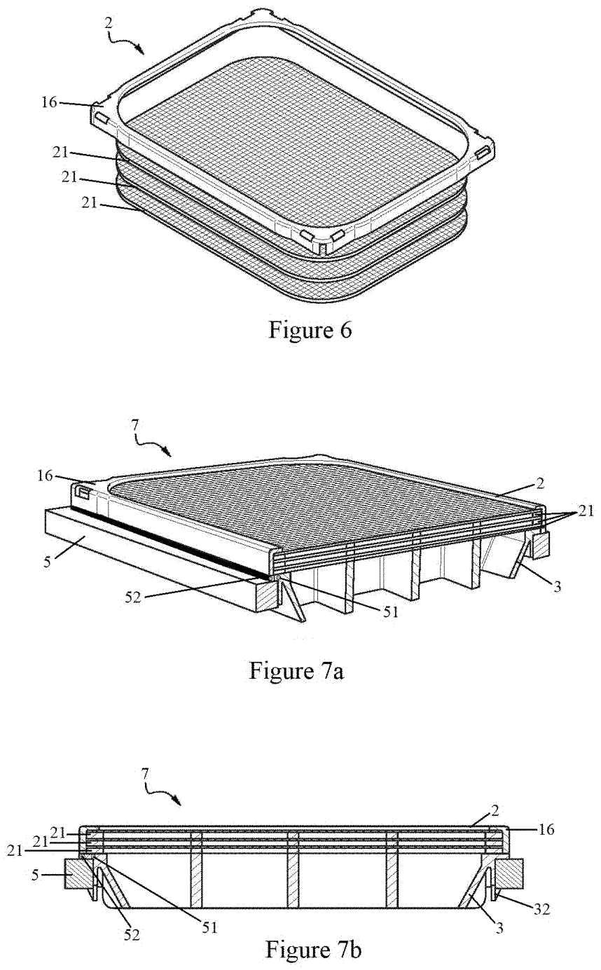

In various embodiments, as indicated in FIGS. 1 and 2, and depicted in more detail in FIGS. 4a, 4b, and 6, filtration component 2 comprises a screen frame 16 comprising one or more screens 21 each comprising a support structure 23. In one embodiment, each screen 21 comprises one more layers of a sieving material such as, but not limited to, a woven mesh, draped across the support structure 23. In other embodiments (not shown), the sieving material may comprise holes (orifices), slits, and/or other openings adapted and configured to filter solid particles from a liquid stream. In one embodiment the woven mesh comprises metal wire, but other materials may be employed. In one embodiment, a mesh comprises aperture openings (not separately labeled) of from about 20 μm to about 4,000 μm, although the invention is not so limited and other aperture opening sizes may be employed.

In one embodiment, mesh 22 is connectively attached about a periphery thereof to an upper surface of support structure 23 (not separately labeled) proximate its periphery. In one embodiment, such connection comprises fusing mesh 22 to the periphery of upper surface of support structure 23 using a heat press, although other methods may be employed. In one embodiment, any excess mesh (not shown) is trimmed off each screen 21 and screen frame 16 is applied over screen(s) 21 to provide a filtration component 2.

FIG. 3a is a perspective view of an embodiment of a positioning component 3 of the present invention, wherein a support structure 25 thereof comprises intersecting support beams 26. In one embodiment, gaps (openings) 29 between support beams 26 are provided for fluid flow through the positioning component 3. In one embodiment, the geometry of positioning component 3 support structure 25 is substantially identical to that of filtration component 2 support structure 23 (discussed below), but the invention is not so limited and geometries of positioning component 3 support structure 25 different than that of the filtration component 2 support structure 23 may be employed. In one embodiment, positioning component 3 may comprise a thermoplastic material, although any suitable material such as, but not limited to, metal or other polymeric materials may be employed, as would be understood by one skilled in the art.

FIG. 3a depicts an embodiment of positioning component 3 comprising one or more first connecting members 31, which are adapted and configured to engage corresponding apertures 12 of filtration component 2 bottom surface 9. In one embodiment, positioning component 3 comprises four first connecting members 31. In one embodiment, first connecting members 31 extend upward from top surface 10 of positioning component 3. In one embodiment, connecting members 31 are disposed proximate one or more of the corners 13 of positioning component 3. In one embodiment, corresponding apertures 12 are disposed proximate one or more of the corners 14 of screen frame 16 (see FIG. 4a).

In one embodiment, a positioning component 3 may comprise one or more second connecting members 32 positioned about the periphery thereof. In one embodiment, positioning component 3 comprises four second connecting members 32. In one embodiment, second connecting members 32 are disposed proximate bottom surface 11 of positioning component 3. In one aspect, connecting members 32 are adapted and configured to reversibly attach positioning component 3 to frame 5. In one embodiment, a connecting member 32 comprises a retention clip comprising a beveled surface and extending slightly outward with respect to the center of positioning component 3 (not separately labeled), such that when the bottom surface 11 of positioning component 3 is positioned (within a frame 5 unit 6) against upper surface 8 of frame 5, the second connecting members 32 are biased slightly inward and upon advancement of a locking surface thereof below frame 5 the second connecting members 32 “click” into an engaged arrangement with frame 5, thereby creating an attachment of positioning component 3 to frame 5 (see FIG. 7b). In one embodiment, connecting members 32 possess enough flexibility that their engagement with frame 5 can be reversed by applying a nominal inward force to connecting members 32 to disengage them from frame 5.

In one aspect, the number as well as the relative positioning of the first connecting members 31 and second connecting members 32 are design variables based in part on the overall size and structure of the positioning components 3, filtration components 2, and frame 5, as would be understood by one skilled in the art.

In the embodiment of FIG. 3a, lower groove 53b, disposed on top surface 10 of positioning component 3, can be more clearly seen. In one embodiment, lower groove 53b extends circumferentially proximate the exterior edges of positioning component 3.

In one embodiment, first connecting members 31 extend slightly outward with respect to a center of positioning component 3 (not separately labeled), such that when an top surface 10 of a positioning component 3 is positioned against a bottom surface 9 of a filtration component 2 (in an orientation as depicted in FIGS. 1 and 3), the first connecting members 31 are biased slightly inward and upon introduction of engagement members 33 thereof into the corresponding apertures 12 the first connecting members 31 “click” into an engaged arrangement with orifices 15 of the apertures 12, thereby creating an attachment of filtration component 2 to positioning component 3. In one embodiment, connecting members 31 possess enough flexibility that their engagement with the orifices 15 can be reversed by applying a nominal force to engagement members 33 (e.g., with a screwdriver or other hand implement). In one embodiment, such displacement force may be applied through the orifice 15.

FIG. 3b depicts a top view of an embodiment of a positioning component 3 of the present invention, showing top surface 10 thereof. FIG. 3c depicts a bottom view of an embodiment of a positioning component 3 of the present invention, showing bottom surface 11 thereof. In the embodiment of FIG. 3c, a second sealing device 52 is circumferentially disposed on bottom surface 11 of positioning component 3. In one aspect, second sealing device 52 may be so disposed when positioning component 3 is positioned into engagement with a frame 5 unit 6, as depicted in FIGS. 7a and 7b. In one embodiment, a portion of positioning component 3 extends downward into unit 5 opening 4 when positioning component 3 is positioned into engagement with a frame 5 unit 6. In one embodiment, as shown in FIG. 3d, second connecting members 32 extends downward below bottom surface 11 of positioning component 3.

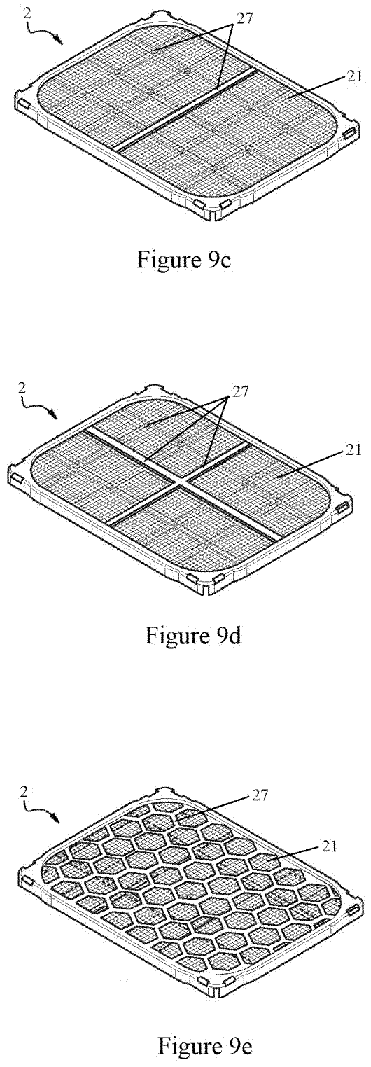

FIG. 4a shows a perspective view of an embodiment of a filtration component 2 of the present invention, and FIG. 4b shows a bottom view of an embodiment of a filtration component 2 of the present invention. In the embodiments depicted in FIGS. 4a and 4b, a filtration component 2 comprises a support structure 23 comprising a grid of intersecting support beams 24. In one embodiment, gaps (openings) 29 between support beams 24 are provided for fluid flow through the filtration component 2. In one aspect, the desired dimensions and configuration of support structure 23 are determined in view of the need to provide adequate support to the mesh during filtration to prevent mesh damage, but to also provide maximization of areas flow areas between the support beams 24. Embodiments comprising different support structure 24 geometries are discuss below with respect to FIGS. 9a-9e. In one embodiment, filtration component 2 may comprise a thermoplastic material, although any suitable material such as, but not limited to, metal or other polymeric materials may be employed, as would be understood by one skilled in the art.

As shown in the embodiment of FIG. 4a, a screen frame 16 may comprise, at one or more corners 14 thereof, one or more orifices 15. In the embodiment of FIG. 4b can be seen one or more apertures 12 on bottom surface 9 of screen frame 16 proximate corners 14 thereof. As described above, apertures 12 are adapted and configured to accommodate first connecting members 31 to provide connection of filtration component 2 and positioning component 3. The embodiment of FIG. 4b also shows an upper groove 53a in a bottom surface 9 of filtration component 2.

FIGS. 5a, 5b, and 5c depict (in cross-sectional side view) embodiments of filtration components 2 of the present invention comprising one, two, and three screens 21, respectively. In one embodiment, each mesh item 22 depicted in FIGS. 5a, 5b, and 5c may comprise a single mesh 22 layer or a plurality of mesh 22 layers, as would be understood by one skilled in the art. As shown in FIGS. 5b and 5c, multiple screens 21 may be stacked within a filtration component 2. In one aspect, when a plurality of identical mesh 22 layers are provided in a screen 21, and the mesh 22 layers are arranged such that the mesh openings line up vertically, the screen 21 comprises a cut point equal to the opening size of the mesh 22 there within. In another aspect, when a plurality of identical mesh 22 layers are provided in a screen 21, and the mesh 22 layers are arranged such that the mesh openings are staggered (i.e., do not line up vertically), or different meshes 22 (i.e., meshes 22 having different mesh opening sizes) are layered and provided in the screen 21, the cut point of the screen can be less than the smallest opening size of the meshes 22 there within. In one embodiment, a filtration component 2 may comprise a plurality of screens 21 having the same or different cut points. Although the embodiments shown encompass three or fewer screens 21, the invention is not so limited and a greater number of screens 21 may be employed in a filtration component 2. In one embodiment, screen(s) 21 is/are secured within a screen frame 16 by a process such as ultrasonic welding, although the invention is not so limited and other affixation means and methods may be employed.

In one embodiment, screen(s) 21 disposed within a filtration component 2 may be permanently installed there within; i.e., when a filtration component 2 is taken out of service, it would need to be replaced by a new filtration component 2, however, the invention is not so limited and in other embodiments, individual screens 21 may be removably positioned within a filtration component 2 such that the filtration component 2 can be disengaged from a positioning component 3 and the screen(s) may be individually replaced, whereby the filtration component 2 containing one or more new screens 21 may be re-engaged with the positioning component 3. In this aspect, portions of a filtration component 2 may be re-used when one or more replacement screens are employed. An exploded view of an embodiment of a filtration component 2 comprising three screens 21 is shown in FIG. 6.

Referring now to FIG. 7a, shown is a perspective cross-sectional view of an embodiment of a portion of a filtration system 7 of the present invention; i.e., a filtration component 2 engaged with a positioning component 3 that is situated in a frame 5 opening 4 is depicted. In this embodiment, three stacked screens 21 are disposed within filtration component 2, filtration component 2 is engaged with positioning component 3, and positioning component 3 is disposed partially within and engaged with frame 5 opening 4. Also visible in FIG. 7a is a first sealing device 51 sandwiched between bottom surface 9 of filtration component 2 and a top surface 10 of positioning component 3, and a second sealing device 52 sandwiched between bottom surface 11 of positioning component 3 and upper surface 8 of frame 5. In one aspect, the first sealing device 51 and second sealing device 52 are employed to prevent fluid and solids from bypassing the desired sieving fluid flow pathway between the positioning component 3, filtration component 2, and opening.4 of a frame 5 unit 6.

FIG. 7b depicts a side cross-sectional view of an embodiment of the filtration system 7 module shown in FIG. 7a. In FIG. 7b, the engagement of second connecting member 32 with frame 5 can be seen. First sealing device 51 and second sealing device 52 are also visible in FIG. 7b.

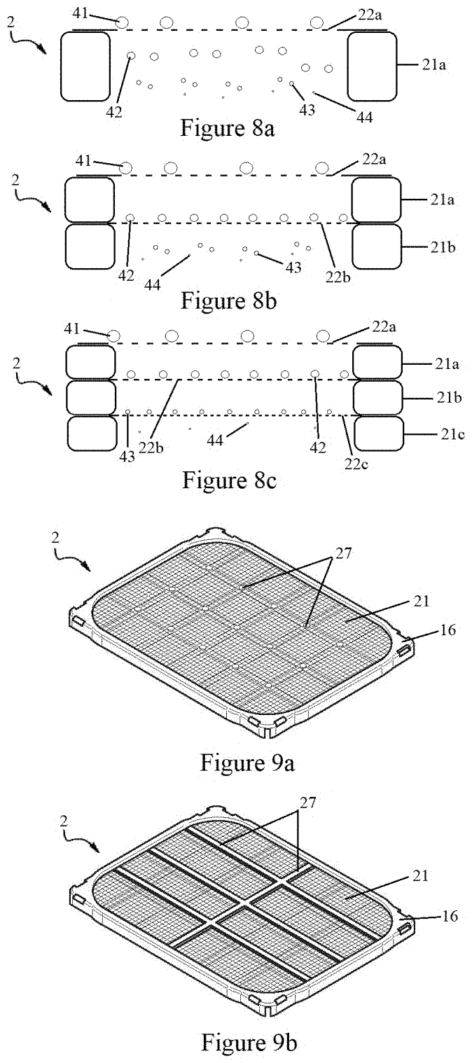

Referring now to FIGS. 8a, 8b, and 8c, a schematic representation of solids being filtered by embodiments of a filtration component 2 of the present invention comprising one, two, and three screens 21, respectively, are shown. For ease of viewing, screen frames 16 are omitted from the depictions of the filtration components 2 in FIGS. 8a, 8b, and 8c. In the embodiment of FIG. 8a, the single screen 21a provides one or more mesh layers 22a having a cut point such that large diameter solid particles 41 in a fluid stream (not shown) are filtered by the mesh 22a, while medium diameter solid particles 42 and small diameter solid particles 43 pass through screen 21a. In the embodiment of FIG. 8b, the filtration component 2 comprises two screens 21a and 21b, whereby medium diameter solid particles 42 that pass through screen 21a are filtered by screen 21b mesh layer(s) 22b (having a smaller cut point than mesh layer(s) 22a), and small diameter solid particles 43 pass through screen 21b. In the embodiment of FIG. 8c, the filtration component 2 comprises three screens 21a, 21b, and 21c, whereby small diameter solid particles 43 that pass through screens 21a and 21b are filtered by screen 21c mesh layer(s) 22c (having a cut point small than mesh layer(s) 22b). In other embodiments (not shown), the number, absolute and relative mesh opening (cut point), and arrangement of a plurality of screens 21 in a filtration component 2 may be varied to accomplish desired filtration efficiency, as would be understood by one skilled in the art. In addition, in a screen 21 comprising a plurality of mesh layers 22, the mesh layers 22 therein may comprise the same or different cut point.

In one aspect, as filtration components 2 are designed to be easily replaced as necessary, and filtration components 2 may have different cut points, it would be useful to have method of readily identifying the cut point of a filtration component 2 so that when replacement is warranted, a worker could easily select the appropriate replacement filtration component 2 from a storage location. In one embodiment, filtration components 2 of the present invention are visually distinguishable by, for example, color. In this aspect, a color coding of filtration components 2 allows for the fast and reliable selection of replacement filtration components 2. In other embodiments, other identifiers could be employed, as would be understood by one skilled in the art.

In one aspect, a plurality of screens 21 may be employed to provide a backup filtration component that functions only to ensure filtering of solids when screen damage has occurred. In one embodiment, for example, a filtration component 2 of the present invention may comprise three screens 21, wherein the top screen 21 mesh 22 comprises aperture openings having a diameter “D,” the middle screen 21 mesh 22 comprises aperture openings having a smaller diameter “½ D,” and the bottom screen 21 mesh 22 comprises aperture openings having a diameter “D.” In this example, under normal operations (i.e., when the top and middle screens 21 are functioning as desired), only particles having a diameter of less than ½ D encounter the bottom screen 21, and so the bottom screen 21 does not perform a filtering function. When, for example, the top screen 21 and the middle screen 21 are damaged such that one or more openings in the meshes 22 thereof are of a size greater than D, the bottom screen 21 mesh 22 functions to prevent solid particles having a diameter greater than D from getting past the filtration system 7. This configuration of screens 21 is merely exemplary, and other configurations may be utilized, as would be understood by one skilled in the art.

Although the meshes 22 shown in FIGS. 8a-8c are depicted as substantially planar (i.e., two dimensional), the invention is not so limited and three dimensional surface geometries may be employed. In one embodiment (not shown), screens 21 may comprise three dimensional (e.g., “wavy”) meshes 22 and/or protuberances on the surface of a mesh 22. These protuberances may be regular in shape, e.g., pyramids, cones, etc., and/or irregular/random in shape, and may be evenly or unevenly spaced apart.

Referring now to FIGS. 9a-9e, embodiments of screens 21 are depicted in which the shape of the support structure 23, and/or the connectivity thereof to the mesh 22, are varied. In the embodiment of FIGS. 9a, 9b, 9c, and 9d, the support structure comprises substantially perpendicularly oriented support beams 24. In the embodiment of FIG. 9a, mesh-support contacts 27 indicate the areas where the mesh 22 is affixed to the support structure 23. In the FIG. 9a embodiment, the affixing contact between mesh 22 and the support structure 23 is limited to points of contact at the intersections of support beams 24. In FIGS. 9b-9d, the affixing contact between mesh 22 and the support structure 23 comprises points of contact (as in FIG. 9a), as well as lines of contact along one or more support beams 24. In the embodiment of FIG. 9e, the support structure 23 comprises hexagonally shaped support beams 24 arranged in a honeycomb-like pattern. As one skilled in the art would appreciate, the relative sizes, shapes, and configuration of support structure 23 beams 24, as well as the configuration of mesh-support contacts 27 may be varied to suit individual robustness and filtration efficiency requirements.

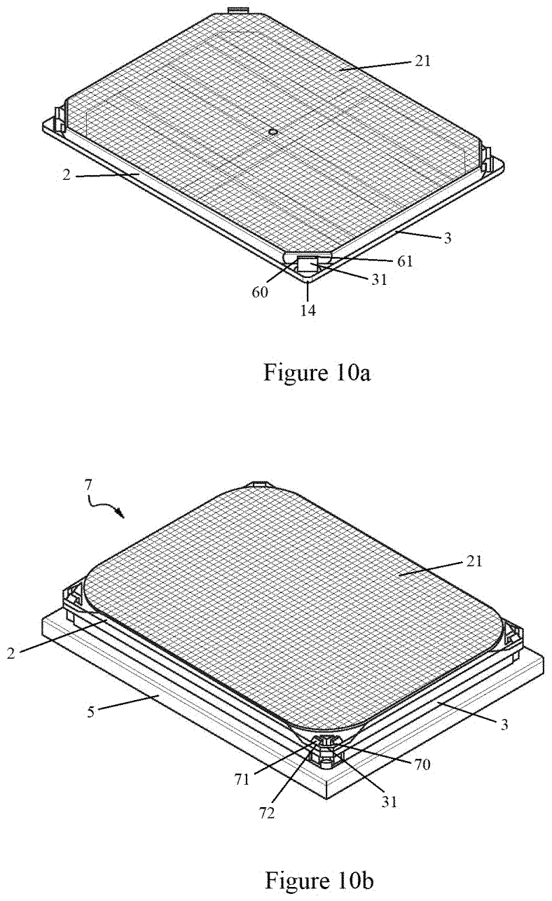

FIG. 10a depicts additional embodiments of a filtration component 2 and a positioning component 3 of the present invention. As shown in the embodiment of FIG. 10a, positioning component 3 first connecting members 31 comprise a retention clip comprising a beveled surface and are oriented upwardly and inwardly proximate corners 13 of positioning component 3. In complementary fashion, the corners 14 of the screen frame 16 embodiment shown in FIG. 10a are cut away and comprise an engagement member 60 , such that when a top surface 10 of the positioning component 3 is positioned against the bottom surface 9 of the filtration component 2 (in an orientation as depicted in FIGS. 1 and 3), the first connecting members 31 are biased slightly outward and upon advancement thereof beyond an edge 61 of engagement members 60, the first connecting members 31 “click” into an engaged arrangement with engagement members 60, thereby creating an attachment of filtration component 2 to positioning component 3. In one embodiment, connecting members 31 possess enough flexibility that their engagement with the engagement members 60 can be reversed by applying a nominal force to engagement members 33 (e.g., with a screwdriver or other hand implement).

FIG. 10b depicts further additional embodiments of a filtration component 2 and a positioning component 3 of the present invention as part of a filtration system7. As shown in the embodiment of FIG. 10b, the positioning component 3 comprises first connecting members 31 comprising a retention clip comprising that extend upward and comprise one or more engagement members 70 comprising a beveled surface extending perpendicularly outward therefrom. As shown in the embodiment of FIG. 10b, screen frame 16 comprises apertures 71 proximate corners 14 thereof, such that when a top surface 10 of the positioning component 3 is positioned against the bottom surface 9 of the filtration component 2 (in an orientation as depicted in FIGS. 1 and 3), the first connecting members 31 are biased slightly inward and upon advancement thereof beyond an edge 72 of apertures 71, the first connecting members 31 “click” into an engaged arrangement with apertures 71, thereby creating an attachment of filtration component 2 to positioning component 3. In one embodiment, connecting members 31 possess enough flexibility that their engagement with the apertures 71 can be reversed by applying a nominal force to engagement members 70 (e.g., with a screwdriver or other hand implement).

Although various embodiments of positioning component 3 first connecting members 31 and devices for utilizing them to reversibly attach positioning component 3 to filtration component 2 are described herein, the invention is not so limited and any suitable reversible attachment mechanism may be employed for this purpose. Similarly, while an embodiment of a positioning component 3 second connecting member 32 is described herein, the invention is not so limited and any suitable reversible attachment mechanism may be employed for the purpose of attaching positioning component 3 to frame 5.

### Operation

In one embodiment, a filtration system 7 of the present invention is provided by engagingly positioning a screen apparatus 1 into each of a plurality of frame 5 units 6. In one embodiment, for each unit 6 a positioning component 3 and a second sealing device 52 are centrally positioned above an opening 4, wherein the second sealing device 52 is circumferentially disposed beneath the bottom surface 11 such that when the positioning component 3 is inserted partially into the opening 4 the second sealing device 52 is sandwiched between bottom surface 11 and the upper surface 8 of frame 5, whereupon the positioning component 3 is advanced downward into opening 4 until the one or more second positioning members 32 of positioning component 3 advance beneath the frame 5 and “click” into engagement therewith. In one embodiment, a filtration component 2 and a first sealing device 51 are centrally positioned above the installed positioning component 3, wherein the first sealing device 51 is circumferentially disposed beneath the bottom surface 9 such that when the filtration component 2 bottom surface 9 is abuttingly positioned against positioning component 3 top surface 10 the sealing device 51 device is sandwiched there between whereby the sealing device 51 is partially disposed within upper groove 53a and lower groove 53b, whereupon the first connecting member(s) 31 are advanced into filtration component 2 apertures 12 until the one or more first positioning members 31 are disposed at least partially within the orifice(s) 15 and “click” into engagement therewith.

In another embodiment, the order of installation is reversed and the filtration component 2 is first engaged with the positioning component 3, whereupon the positioning component (with the filtration component coupled thereto) is installed into the frame 5 opening 4, as described above.

To remove a filtration component 2 from an installed screen apparatus 1, positioning component 3 first connecting member(s) 31 is/are manipulated (e.g., biased inward) to disengage engagement member(s) 33 from filtration component 2 orifice(s) 15. The filtration component 2 is then displaced from the positioning component 3. To remove a positioning component 3 from an installed screen apparatus 1, positioning component 3 second connecting member(s) 32 is/are manipulated (e.g., biased inward) to disengage second connecting member(s) 32 from frame 5.

In another embodiment, the order of removal is reversed and the positioning component 3 is removed from frame 5 unit 6 opening 4 first, and filtration component 2 may be disengaged from positioning component 3 as described above.

In one aspect, a filtration system 7 comprising one or more screen apparatuses 1 may be utilized to filter liquids such as, but not limited to, drilling fluids, wherein damage to screen 21 meshes 22 can be addressed by removal of only the affected filtration component 2 (or entire screen apparatus 1, if desired), whereupon a replacement filtration component 2 is provided to the screen apparatus 1 and fluid filtration can continue. In one aspect, replacement screen(s) 21 may be installed on the removed filtration component 2 for reuse.

In one embodiment, a typical drilling fluid filtration operation comprises positioning an embodiment of a filtration system 7 of the present invention on a shaker bed, as would be understood by one skilled in the art. Since a typical shale shaker utilizes a vibratory motor to generate motion to the shaker bed, it is important to ensure that a filtration system employed therewith remains in a functional arrangement during the filtration process and is not displaced by the vibrations. As described herein, the component securement features of a filtration system 7 meet this requirement.

### Method

In one embodiment, a method of utilizing a filtration system 7 of the present invention comprises:

A Frame Provision Step comprising providing a frame, such as a frame 5, comprising a plurality of subdivided units, such as units 6, with each unit comprising an opening, such as an opening 4;

A Positioning Component Installation Step comprising providing a plurality of positioning components , such as positioning components 3, each proximately above a frame unit opening, and inserting at least a portion of a bottom section of each positioning component into the proximate opening such that at least a portion of one or more positioning component second connecting members, such as second connecting members 32, abuts a bottom surface of the frame, whereby the positioning component is securely, but reversibly, engaged with the frame;

A Filtration Component Installation Step comprising providing a plurality of filtration components, such as filtration components 2, each proximately above an installed positioning component, and lowering each filtration component onto a top surface of an installed positioning component such that at least a portion of each of one or more positioning component first connecting members, such as first connecting members 31, are provided within a filtration component aperture, such as an aperture 12, whereby at least a portion of an engagement member of each first connecting member, such as an engagement member 33, is cooperatively interacts with a filtration component aperture orifice, such as an orifice 15, whereby the filtration component is securely, but reversibly, engaged with the positioning component;

A Filtration Step comprising flowing a particulate containing liquid downward through a top surface of the filtration component that comprises a screen, such as a screen 21, the screen comprising one or more layers of a mesh, such as mesh 22, whereby the particulate matter in the liquid is filtered out and the liquid flows through filtration component openings, such as openings 28, through the positioning component via openings, such as openings 29, therein, and through the frame unit opening; and

(Optionally) A Filtration Component Replacement Step comprising disengaging at least one filtration component from the positioning component with which it is engaged, and installing another filtration component onto the positioning component.

The above embodiment of a method of the present invention is merely exemplary, and additional embodiments of a method of utilizing a filtration system 7 of the present invention consistent with the teachings herein may be employed. In addition, in other embodiments, one or more of these steps may be combined, repeated, re-ordered, or deleted, and/or additional steps may be added.

While the preferred embodiments of the invention have been described and illustrated, modifications thereof can be made by one skilled in the art without departing from the teachings of the invention. Descriptions of embodiments are exemplary and not limiting. The extent and scope of the invention is set forth in the appended claims and is intended to extend to equivalents thereof. The claims are incorporated into the specification. Disclosure of existing patents, publications, and known art are incorporated herein to the extent required to provide reference details and understanding of the disclosure herein set forth.

I claim:

1. A shale shaker filtration system comprising:
one or more screen apparatuses; and
a system frame;
wherein said system frame is subdivided into a plurality of units, each said unit comprising an opening; and
wherein at least one said screen apparatus comprises:
a filtration component; and
a positioning component;
wherein:
said filtration component comprises a screen frame;
said filtration component comprises one or more layers of sieving material comprising a plurality of openings, at least one said layer supported by a filtration component support structure; and
said filtration component support structure is contained at least partially within said screen frame; and
said positioning component comprises:
a positioning component support structure;
one or more first connecting members; and
one or more second connecting members;
wherein:
said filtration component is reversibly attached to a positioning component by engagement of one or more of said first connecting members with said filtration component;
said positioning component is at least partially positioned within a system frame unit opening; and
said positioning component is reversibly attached to said system frame by engagement of one or more of said second connecting members with said system frame.

2. The shale shaker filtration system of claim 1, comprising one or more sealing devices.

3. The shale shaker filtration system of claim 2, wherein at least one said sealing device comprises an O-ring.

4. The shale shaker filtration system of claim 1, wherein at least one said layer of sieving material comprises wire mesh.

5. The shale shaker filtration system of claim 1, wherein said positioning component is reversibly attached to said system frame by direct engagement of one or more of said second connecting members with said system frame.

6. The shale shaker filtration system of claim 1, wherein said filtration component comprises a plurality of layers of sieving material.

7. The shale shaker filtration system of claim 6, wherein at least two of said layers of sieving material comprise different size openings.

8. The shale shaker filtration system of claim 6, wherein said plurality of layers of sieving material is supported by a single filtration component support structure.

9. The shale shaker filtration system of claim 2, wherein at least one said sealing device is at least partially disposed intermediate said filtration component and said positioning component.

10. The shale shaker filtration system of claim 9, wherein at least one said sealing device is at least partially positioned in a groove selected from the group consisting of;
a groove disposed in a bottom surface of said filtration component;
a groove disposed in a top surface of said positioning component; and
both a groove disposed in a bottom surface of said filtration component and a groove disposed in a top surface of said positioning component.

11. The shale shaker filtration system of claim 2, wherein at least one said sealing device is at least partially disposed intermediate said positioning component and said system frame.

12. The shale shaker filtration system of claim 11, wherein at least one said sealing device is at least partially positioned in a groove disposed in a bottom surface of said positioning component.

13. The shale shaker filtration system of claim 4, wherein said wire mesh comprises mesh openings of from about 20 μm to 4,000 μm.

14. A method of filtering a liquid utilizing a shale shaker comprising:
providing the shale shaker filtration system of claim 1;
positioning said shale shaker filtration system in a shale shaker bed; and
introducing said liquid to a top surface of said filtration system, whereby said liquid flows through said one or more screen apparatuses to filter solid particles from said liquid.

15. The method of claim 14, wherein said liquid is a drilling fluid.

16. The method of claim 14, comprising;
disengaging a first filtration component from a positioning component to with which it is engaged; and
replacing said first filtration component with a second filtration component by engaging said second filtration component with said positioning component;
wherein said replacing said first filtration component with said second filtration component is accomplished without disengaging said positioning component from said system frame.

17. The method of claim 14, comprising;
removing a first screen apparatus from a system frame unit opening by disengaging the positioning component of said first screen apparatus from said system frame; and
replacing said first screen apparatus with a second screen apparatus in that system frame unit opening by engaging the positioning component of said second screen apparatus with said system frame;
wherein said replacing said first screen apparatus with said second screen apparatus is accomplished without removing said system frame from said shale shaker bed.

18. The method of claim 14, wherein at least one said sieving material layer comprises wire mesh.

19. The method of claim 18, wherein said wire mesh comprises mesh openings of from about 20 μm to 4,000 μm.

20. The method of claim 14, wherein at least one said screen apparatus comprises at least one sealing device.
